(19) United States
(12) Patent Application Publication
(10) Pub. No.: US 2009/0327097 A1
(43) Pub. Date: Dec. 31, 2009

(54) METHOD AND SYSTEM FOR CONDUCTING AN AUCTION OVER A NETWORK

(76) Inventor: Vito A. Palmieri, Mineola, NY (US)

Correspondence Address: MICHAEL J. PORCO, P.O. BOX 1341, BAYVILLE, NY, 11709, US

(21) Appl. No.: 12/494,112

(22) Filed: Jun. 29, 2009

Related U.S. Application Data
(60) Provisional application No. 61/076,649, filed on Jun. 29, 2008.

(51) Int. Cl. G06Q 30/00; G06Q 20/00; G06Q 50/00

(52) U.S. Cl. 705/26

(57) ABSTRACT

A method and system for conducting an online auction of an item, e.g., real property such as a house, commercial real estate, a vacant lot, etc., are provided. The system and method provides for listing a property of interest for sale via an auction web site. Bidders will buy individual bids to place at least one bid amount on the listed property in an attempt to buy the property far below the fair market value of the property, i.e., the cost of the bid plus the amount of the bid. Once the auction period is closed, the property will be awarded to the bidder with the lowest unique bid. The revenue or proceeds generated from the purchase price of each bid will be used to purchase the property from the seller, provide a fee to the auction web site and provide a fee to the proper government entity.

### PRIORITY

This application claims priority to U.S. Provisional Patent Appl. No. 61/076,649, filed Jun. 29, 2008, the contents of which are hereby incorporated by reference in its entirety.

### BACKGROUND

1. Field

The present disclosure relates generally to electronic commerce and online auction systems, and more particularly, to a method and system for conducting an online auction of a property, e.g., a house, home, commercial real estate, a vacant lot, etc.

2. Description of the Related Art

Online Internet auctions are now a major component of Internet commerce. Companies such as eBay Inc. of San Jose, Calif., uBid Inc. of Chicago, Ill., and Yahoo! Inc. of Santa Clara, Calif. conduct billions of dollars worth of online auctions on an annual basis. Merchandise and services of all sorts are regularly bought and sold through these and other auction web sites.

Generally, a seller of goods or services registers with one of the aforementioned web sites to create a user account. The seller then creates a listing for the item the user desires to sell. Typically, the listing will include a description of the item and one or several pictures of the item. The seller will then set a minimum starting bid price and optionally a reserve bid price, i.e., a secret minimum price the seller is willing to accept for the item. Finally, the seller will set a time period for which the auction will run, e.g., 7 days. During the time period of the auction, potential buyers or bidders will place bids on the listed item. After the auction time period has expired, the highest bidder will be awarded the item and will purchase the item from the seller, preferably, through an e-commerce transaction employing several available methods including PayPal™.

However, on these conventional auction web sites, a bidder is not charged for placing a bid and may place hundreds or thousands of bids without ever being charged for any of the bids. The revenue generated by the hosting auction web site is merely a fee to the seller for listing an item. Furthermore, if the item is a high priced item, most bidders will refrain from bidding if the item is well above their price range.

Therefore, a need exists for techniques for auctioning an item where a bidder can bid on an item and only pay a small fraction of the fair market value of the item.

### SUMMARY

A method and system are provided for conducting an online auction of real property, e.g., a house, home, commercial real estate, a vacant lot, etc., is provided. The system and method provides for listing a property of interest for sale via an auction process. Bidders, e.g., potential buyers, will buy individual bids to place at least one bid amount on the listed property in an attempt to buy the property by an individual bidder far below the fair market value of the property. Bidders will have the opportunity to purchase a property for the cost of the bid plus the amount of the bid. Once the auction period is closed, the property will be awarded to the bidder with the lowest unique bid. The revenue or proceeds generated from the purchase price of each bid will be used to purchase the property from the seller, provide a fee to the hosting server or entity of the auction web site and provide a fee to the proper government entity. In certain embodiments, the revenue collected will be used to pay for a predetermined number of years of taxes on the property.

The system and method of the present disclosure will stimulate multiple industries while building consumer confidence in government. The concept is that any person can log onto a web site and “bid” on a property or home. Unlike conventional auction sites, the system and method of the present disclosure (in one embodiment, embodied as a web site at onelowbid.com) will utilize a new “lowest unique bid” format. This format is easy to understand, simple to use, and will generate excitement. The system and method of the present disclosure will also generate revenue for struggling communities, local municipalities and the Federal government while rebuilding the hardest hit communities and giving the average hard working individuals a chance for the American dream: home ownership.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a flow diagram of a method and system for conducting an auction over a network in accordance with an embodiment of the present disclosure;

FIG. 2 is an exemplary server for use in the system shown in FIG. 1;

FIG. 3 is a flow diagram illustrating a method for listing an item, e.g., a property, house, commercial real estate, etc., in accordance with an embodiment of the present disclosure; and

FIG. 4 is a flow diagram illustrating a method for distributing option monies collected when an auction transaction is completed with the lowest unique bidder.

The appended drawings illustrate exemplary embodiments of the present disclosure and, as such, should not be considered as limiting the scope of the disclosure that may admit to other equally effective embodiments. Correspondingly, it has been contemplated that features or steps of one embodiment may beneficially be incorporated in other embodiments without further recitation. In some embodiments, particular method steps of the discussed methods are performed in the depicted order. In alternate embodiments, in the respective methods, at least two method steps or portions thereof may be performed contemporaneously, in parallel, or in a different order.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A method and system are provided for conducting an online auction of a property of interest. The system and method of the present disclosure enables a user, e.g., a bidder, to purchase one or more bids at a predetermined price where the bid(s) will be used in an attempt to purchase a property far below a predetermined price, e.g., the fair market value, a mortgage amount, or a negotiated price, etc.

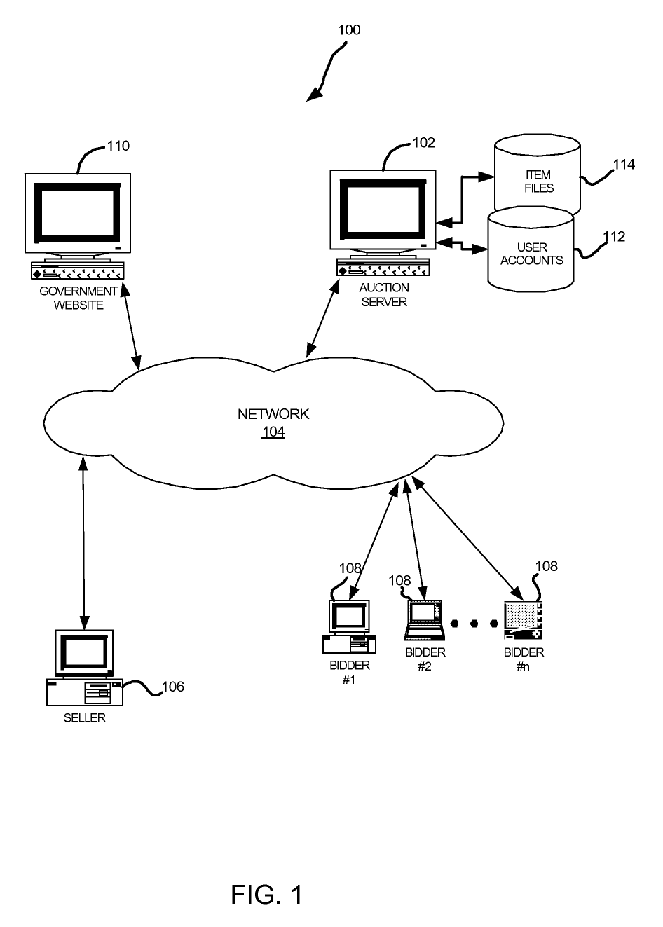

In utilizing the methods and systems of the present disclosure described herein, a user will be able to accomplish the various applications of the disclosure which are described below in relation to FIG. 1, which illustrates an overall flow diagram of the method and system 100 of the present disclosure.

Referring to FIG. 1, an auction server 102 is provided for hosting an auction web site wherein the auctioneer will offer the sellers or home owners items, e.g., a property or house, for sale and potential buyers will bid on the items for sale. All transactions to be described will occur electronically, via a hardwired or wireless connection, over a network 104 of computers, e.g., the Internet. Each of the users of system 100, e.g., seller 106, bidder(s) 108, a government entity 110, e.g., a county, village, etc., will be coupled to the auction server 102 via a client application, e.g., an Internet browser, and will access the auction server 102 via a web interface, e.g., an HTML constructed web page. The auction server 102 includes a plurality of databases for storing user account information 112 and for item information 114 relating to the items or properties presented or posted for sale.

In using the system 100, a seller 106 will create a user account including name, address, contact information, e-mail address, acceptable payment options, etc. which will be stored for the seller in the user account database 112. Once the seller 106 establishes a user account, the seller 106 may post items that they desire to sell, for example a house in pre-foreclosure, a commercial building, vacant lot, etc. When posting the item for sale, the seller 106 will provide a description of the item or property and one or several pictures of the item or property. Once posted, potential buyers or bidders 108 may view the listing for the item and place a bid on the item, e.g., an amount the bidders is willing to spend to purchase the item. After the auction time period has expired, the auction server 102 will determine the lowest unique bidder and contact the bidder to inform them that they are the lowest unique bidder and provide them with instruction on how to complete the purchase transaction, preferably via an e-commerce method such as PayPal™.

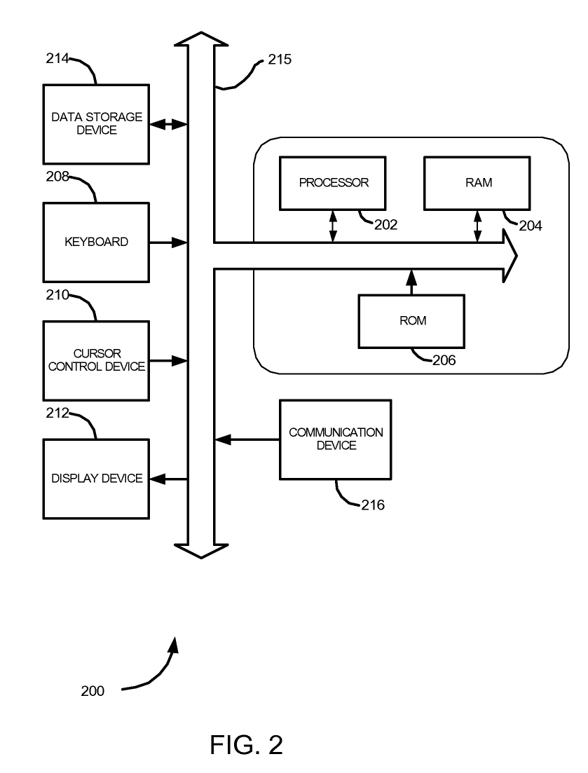

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as server 102. Referring to FIG. 2, preferably, the machine 200 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. A system bus 215 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform by various interfaces and bus structures, such as a parallel port, firewire (IEEE 1394) serial port or universal serial bus (USB). One such peripheral device may include a communications device 216, e.g., a modem, network interface card (NIC), satellite relay, wireless connection, etc., for enabling communications from the servers 102, 116 to various clients, e.g., seller 106 and bidders 108. Other peripheral devices may include additional storage devices 214 and a printer.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The server 102, seller client 106 and bidder client 108 may operate in a networked environment using logical connections to one or more remote computers. The remote computer(s) may be a personal computer, a server, a router, a network PC, a peer device or other common network node, and typically includes many or all of the elements described above relative to the servers 102, 116. It is to be appreciated that the network may be a local area network (LAN), wide area network (WAN), the Internet or any known network that couples a plurality of computers to enable various modes of communication via network messages. Furthermore, the server 102, seller client 106 and bidder client 108 will communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc.

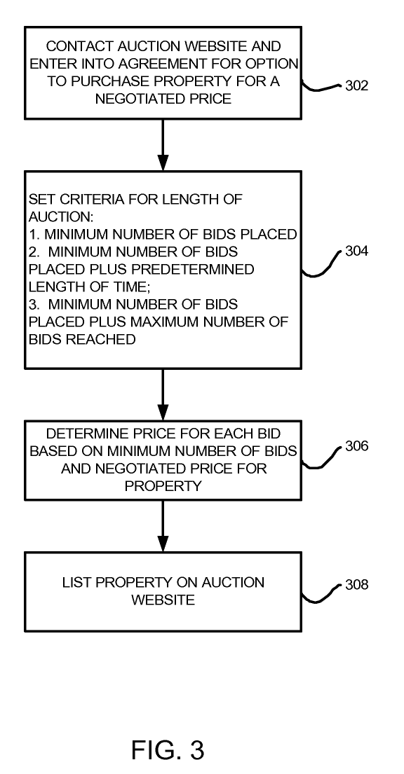

With reference to FIGS. 1, 3 and 4, the method and system of the present disclosure will now be described.

Initially, a user, e.g., a seller 106, wishes to participate in an online auction process with the objective of selling or disposing of their property and associated mortgage. In step 302, a property owner, e.g., seller 106, contacts the auction server 102 via a web site being hosted thereon (or visa versa, i.e., the hosting party of the server 102 contacts the property owner). The property owner can be a bank, corporation, limited liability company or individuals who have fee simple title to the properties in question whether residential or commercial. The auction web site enters into an agreement for an option to purchase the property from the property owner within a given time frame and to place their property on the web site with a pre-determined value of the property of either market value or the mortgage amount owed whichever is greater that has been negotiated and agreed upon by the property owner and the auction web site.

Next in step 304, the auction web site will set the criteria for the length of the auction for a particular property. In one embodiment, the criteria will be a predetermined minimum number of bids. In another embodiment, the criteria will be a predetermined minimum number of bids and a predetermined time period after the minimum number of bids are reached. In a further embodiment, the criteria will include a minimum number of bids and a predetermined maximum number of bids.

At step 306, the auction server 102 will determine the predetermined price for each bid based on the minimum number of bids and the negotiated price for the house. In this manner, the revenue generated by bidders purchasing the bids will cover the negotiated price to the seller 106 or property owner, and in certain embodiments, provide a profit or auction fee to the auction server 102. For example, if the negotiated price for the house is $400,000.00 with a 10 percent fee to the property owner server 102, the auction server will need to generate at least $440,000.00. If the auction server determines the minimum number of bids to be 4,400, the price for each bid will be $100.00. Alternatively, the auction server 102 could select the price per bid first and then determine the minimum number of bids to cover all costs.

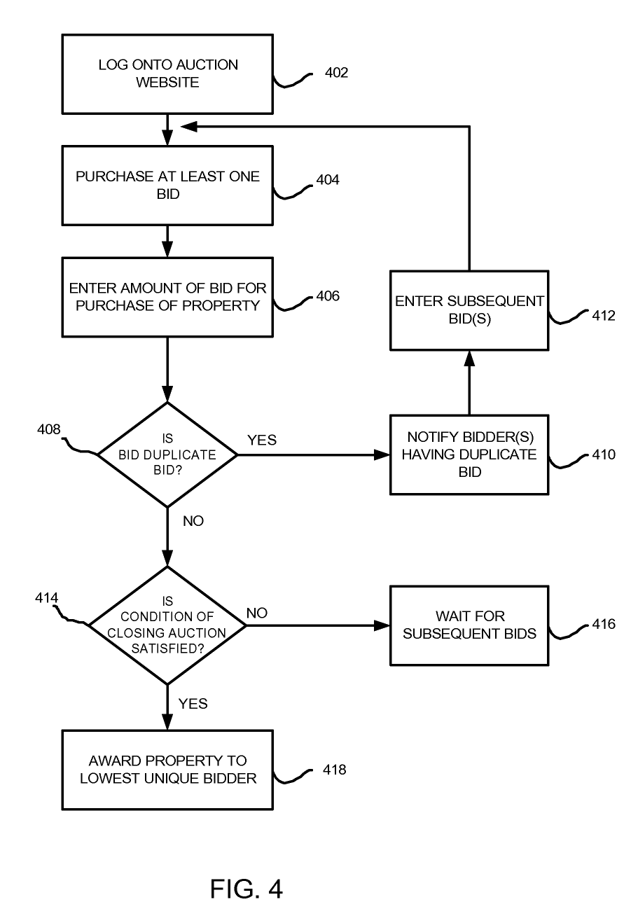

Once the predetermined number of bids and price per bid is determined, the property is listed on the auction web site, step 308. Once the auction begins, potential buyers or bidders 108 may place bids via the web site hosted by the auction server 102 for the property up for sale. As opposed to conventional online auctions where there is no charge to place a bid on an item and a bidder may place several bids throughout the auction without being charged for placing the bids, a bidder will be charged for each bid placed as will be described in detailed below in conjunction with FIG. 4.

In step 402, a bidder 108 will log into the auction web site. In one embodiment, the bidder 108 will register for use of the auction web site. A registered bidder is a validated user of the web site that will have a secure username/password for access to place bids. During the registration process, the bidder 108 will supply the auction server 102 will the bidder's name, address, contact information such as a telephone number, e-mail address, an instant message screen name, etc., and optionally payment information such as a credit card number for future purchases of bids. By completing the registration process, each of the bidders shall have to agree in advance of participating in the program that they will receive a deed with restrictions on the percentage or amount of money that winning bidders will be able to re-mortgage the properties for anywhere from three (3) to (5) years after they receive the premises (i.e., only twenty five (25%) of the market value during the 3 or 5 year period). The agreement between the bidders and the auction web site may also condition any of these cash out refinances upon using some or all of the funds for improving the premises.

In step 404, the bidder 108 will purchase at least one bid. Each bid will cost the registered bidder the predetermined fixed amount payable up front through a payment gateway and merchant account set up by the auction web site 102, e.g., credit card or pre-payment. It is contemplated that the bidder 108 may purchase several bids at one time or purchase them as a package of for example ten bids.

Next in step 406, the bidder 108 will enter a dollar amount that they would like to bid on the house up to a maximum bid amount. (i.e., $ 0-$500.00). The auction server 102 will compile all bids in a secure database that will let the bidders know if they have the lowest unique bid at the end of the auction period. In step 408, the auction server will determine if the entered bid is a duplicate bid of a previously entered bid by another bidder. If the bid entered in step 406 is a duplicate bid, the auction server 102 will immediately notify the bidder 108 that they have entered a duplicate bid (i.e., a bid already entered by a previous bidder), step 410. For example, if a bidder places a bid for $2.51, the program of the web site will immediately tell the bidder if another bidder has placed the same bid ($2.51), i.e., the bid in not unique. If the bidder 108 entered a duplicate bid, the bidder 108 may enter subsequent bids, at step 412, and the process will revert to step 404.

Multiple bids are accepted and encouraged. For example, if a bidder enters five bids for the following amounts: (1) $2.37; (2) $1.59; (3) $12.12; (4) $18.99; and (5) $21.32. The auction server 102 will let the bidder 108 know which bids are duplicates and which are unique. In this illustrative example, the auction server 102 may indicate to the bidder 108 that bids (1),(2) and (5) are duplicate bids and are not in the running for the property. Furthermore, the auction server 102 will indicate that bids (3) and (4) are unique and are in the running. In this example, where bids are priced at $100.00 per bid, the bidder 108 would have paid $500.00 with only two bids still valid at this point.

In one embodiment, if the bidder 108 has entered a bid previously entered by another bidder, the auction server 102 will note that the bid is no longer a unique bid and will notify the other previous bidder that they no longer have a unique bid. This notification may be by a phone call, e-mail, an instant message, a text message to a mobile phone, etc. In this manner, bidders will be encouraged to enter new bids to stay in the running for purchasing the property.

The auction server 102 will then determine if the auction is closed at step 414. If one of the above predetermined conditions defined in step 304 is not met, the auction server 102 will wait for subsequent bids at 416. Otherwise if the predetermined conditions are met, the auction will close and the winning bidder is announced at step 418.

It is to be appreciated that if for some reason the auction can not be completed, e.g., the minimum number of bids is not reached, the bidders will be credited for each bid purchased for that particular auction. For example, if a bid purchased five bids for $100.00 each (i.e., $500.00) and the auction is not completed, the bidder will be credited $500.00 for future auctions.

The winning bidder will be notified that he/she has won the property. The auction server 102 will then complete the purchase of the property from the existing owner according to the terms of the contract for the pre-determined amount. The auction server 102 will then finalize the transaction with the winning bidder. The winning bidder will also have his property taxes paid in full for five (5) years by the auction web site, his transfer and or gift or gain taxes due at time of purchase, if any, to the IRS or State will also be paid in full for the transaction. In one embodiment, the seller 106 shall also receive an additional ten (10%) percent of the pre-determined price if the property is being sold at less than market value to him/her from the auction server 102.

In a further embodiment of the present disclosure, after the transactions are completed with the new and prior property owners and all fees and disbursements are paid, the auction server 102 will then split the profits in some predetermined percentages to be paid to the local, state or federal governments and applied directly to property taxes to the State, City, County or local municipality and the federal government to assist in the communities where the property was sold.

In a further embodiment, should the bid winner choose to sell the premises or property they have to sell it for market value, which has been determined at the time of sale by an appraisal of the property, to a bona fide purchaser in an arms length transaction. Anyone who sells prior to the vesting period of 3 to 5 years shall also have to pay any and all taxes as well as any deferred taxes and a penalty for not keeping the property for the full period, i.e., like a prepayment penalty to the government entities involved.

As an illustrative example, a seller 106 enters into a contact with the auction server 102 for the purchase of a $400,000.00 home. In this example, the minimum number of bids is set at 10,000 bids and the price per bid is $100.00. Therefore, if a bidder would like to place a bid, the bidder would purchase a bid for $100.00. If, for example, the bidder place a bid of $50.95 and is later determined to be the winner, i.e., the bidder with the unique lowest bid, the bidder will purchase the house having a fair market value of $400,000.00 for $150.95 (the price of the bid plus the bid amount or $100.00+$50.95). In a further example, if the bidder needed fifteen bids to win and the winning bid was for $ 112.69, the bidder will purchase the house for $ 1,612.69 (the price of the bids plus the bid amount or $1500.00+$112.69).

If the auction is closed when the minimum number of bids is reached, i.e., 10,000 bids, the revenue produced by the bidders will be $ 1,000,000.00. The negotiated price will be paid to the seller 106, here, $400,000.00. The taxes due by the winning bidder will be paid directly to the IRS by the auction web site, here would approximately be $120,000.0. The auction web site will also pay for the taxes on the house for a predetermined number of years, here 5 years at $8,000.00 or $40,000.00 total. Additionally, a 10 percent premium may be paid to the seller, should the selling price be just for the mortgage amount owed, if for market value the seller will receive the equity over the mortgage payoff and no additional compensation. In this example, the premium would be $40,000.00. After the above described payouts, the remaining balance would be $400,000.00. Of the remaining balance, a predetermined percentage would be paid to the government entity wherein the property is located e.g., the state, county and or city, town or village, i.e., a property sold in Hempstead shall share the proceeds with the Town of Hempstead, County of Nassau and State of New York to be specifically applied to school and property taxes, the remaining balance would be retained by the auction web site as their fee. In this example, the government will receive seventy-five percent or $300,000.00 and the auction web site will receive twenty-five percent or $100,000.00.

It is to be appreciated that the above example is for illustration purposes only and many other scenarios and predetermined percentages may occur. Furthermore, it is to be appreciated the system and method of the present disclosure may be employed to dispose of other items in addition to real property, for example, personal property such as cars, boats, jewelry, etc.

With the system and method of the present disclosure, a winning bidder could purchase a property or home for as little as $100.01 (i.e., a bid of $0.01 and the purchase price of one bid for $100.00). The system and method of the present disclosure will generate huge revenue with no administration or cost; put equity back into the properties sold, repay banks for non performing properties, improve the banks cash flow, build confidence with constituents as the number of house foreclosures in a particular county drops; rebuilds communities devastated in the wake of a real estate crisis; provides the absolute lowest cost housing possible; instills confidence within the banking community; prevents foreclosure and saves the credit of seller and lifts them of debt burden; and creates a public relations windfall.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for auctioning at least one item over a network, the method comprising the steps:
(a) providing a web site for presenting the at least one item for auction hosted by at least one server in communication with the network;
(b) setting a criteria for a length of the auction;
(c) receiving an indication of at least one bid by the web site from at least one bidder;
(d) receiving a bid amount associated to the at least one bid by the web site, the bid amount being entered by the at least one bidder via a client device, each of the at least one bid costing the at least one bidder a predetermined purchase amount;
(e) determining if the bid amount matches previously received bid amounts, wherein if the bid amount matches at least one previously received bid amount, discarding the bid amount;
(f) iteratively repeating above steps (c)-(e) until the criteria until the length of the auction is met, and (g) awarding the at least one item to the at least one bidder entering the lowest, unique bid amount.

2. The method as in claim 1, wherein the criteria for the length of the auction is a predetermined minimum number of bids placed.

3. The method as in claim 1, wherein the criteria for the length of the auction is a predetermined minimum number of bids placed plus a predetermined length of time.

4. The method as in claim 1, wherein the criteria for the length of the auction is a predetermined minimum number of bids placed and a predetermined number of maximum bids reached.

5. The method as in claim 1, wherein the predetermined purchase amount for each of the at least one bid is determined by a predetermined minimum number of bids and a predetermined value of the at least one item.

6. The method as in claim 1, further comprising distributing a first predetermined amount of a total received predetermined purchase amounts to a seller of the at least one item.

7. The method as in claim 6, further comprising distributing a second predetermined amount of the total received predetermined purchase amounts to the web site.

8. The method as in claim 7, wherein the at least one item is a piece of real property.

9. The method as in claim 8, further comprising distributing a third predetermined amount of the total received predetermined purchase amounts to a government entity where the real property is located.

10. The method as in claim 9, further comprising distributing a fourth predetermined amount of the total received predetermined purchase amounts to pay a predetermined number of years of real property taxes associated with the real property.

11. An apparatus for auctioning at least one item over a network comprising:
means for providing a web site for presenting the at least one item for auction hosted by at least one server in communication with the network;
means for setting a criteria for a length of the auction;
means for receiving an indication of at least one bid by the web site from at least one bidder;
means for receiving a bid amount associated to the at least one bid by the web site, the bid amount being entered by the at least one bidder via a client device, each of the at least one bid costing the at least one bidder a predetermined purchase amount;
means for determining if the bid amount matches previously received bid amounts, wherein if the bid amount matches at least one previously received bid amount, discarding the bid amount; and
means for awarding the at least one item to the at least one bidder entering the lowest, unique bid amount, when the criteria for the length of the auction is met.

12. The apparatus as in claim 11, wherein the criteria for the length of the auction is a predetermined minimum number of bids placed.

13. The apparatus as in claim 11, wherein the criteria for the length of the auction is a predetermined minimum number of bids placed plus a predetermined length of time.

14. The apparatus as in claim 11, wherein the criteria for the length of the auction is a predetermined minimum number of bids placed and a predetermined number of maximum bids reached.

15. The apparatus as in claim 11, wherein the predetermined purchase amount for each of the at least one bid is determined by a predetermined minimum number of bids and a predetermined value of the at least one item.

16. The apparatus as in claim 11, further comprising means for distributing a first predetermined amount of a total received predetermined purchase amounts to a seller of the at least one item.

17. The apparatus as in claim 16, further comprising means for distributing a second predetermined amount of the total received predetermined purchase amounts to the web site.

18. The apparatus as in claim 17, wherein the at least one item is a piece of real property.

19. The apparatus as in claim 18, further comprising means for distributing a third predetermined amount of the total received predetermined purchase amounts to a government entity where the real property is located.

20. The apparatus as in claim 19, further comprising means for distributing a fourth predetermined amount of the total received predetermined purchase amounts to pay a predetermined number of years of real property taxes associated with the real property.
